(19) United States
(12) Patent Application Publication
(10) Pub. No.: US 2022/0061583 A1
(43) Pub. Date: Mar. 3, 2022

(54) Grinding Attachment and Coffee Machine

(71) Applicant: Melitta Europa GmbH & Co. KG, Minden (DE)

(72) Inventor: Andreas SACHTLEBEN, Minden (DE)

(73) Assignee: Melitta Europa GmbH & Co. KG, Minden (DE)

(21) Appl. No.: 17/382,125

(22) Filed: Jul. 21, 2021

(30) Foreign Application Priority Data
Sep. 2, 2020 (DE) 10 2020 122 938.0

(51) Int. Cl. A47J 31/42; A47J 42/50; A47J 42/40

(52) U.S. Cl. CPC A47J 31/42; A47J 42/40; A47J 42/50

(57) ABSTRACT

A grinding attachment for use with a coffee machine an upper grinding tool arranged inside a casing, and a lower grinding tool (11), which can be rotated rotatable relative to the upper grinding tool during a grinding operation. An adjustment device adjusts a degree of grinding of a material to be ground with the grinding tools. The upper grinding tool is attached to a support. The support for the upper grinding tool is displaceable in the vertical direction and is secured torque-proof on an element of the adjustment device. The adjustment device comprises a guide for the support which, during the rotating of the adjustment element, moves the support together with the upper grinding tool in the vertical direction for adjusting the grinding gap.

### CROSS-REFERENCE TO RELATED APPLICATIONS

This application claims priority to German Application No. 10 2020 122 938.0 filed Sep. 2, 2020, the entire content of which is incorporated herein by reference.

### FIELD OF THE INVENTION

The present invention relates to a grinding attachment, in particular used for a coffee machine, with an upper grinding tool arranged inside a casing and a lower grinding tool which can rotate relative to the upper grinding tool during a grinding operation, wherein a device is provided for adjusting the degree of grinding of the product to be ground up and wherein the upper grinding tool is attached to a support, and further relates to coffee machine.

### BACKGROUND

PCT publication WO 2014/026485 A1 discloses an automatic coffee machine with a grinding attachment that permits adjusting the grinding gap between two grinding tools, for adjusting the degree or fineness of grinding. A rotary knob functions to convert a rotational movement to a translational movement in order to adjust the degree of grinding. The adjustment device for adjusting the degree of grinding requires a gear and thus requires a relatively large installation space.

Grinding tools disclosed in WO 2020/002493 A1 are furthermore known for high-quality coffee machines for which the force exerted onto the first grinding tool or the second grinding tool can be adjusted during operation. These types of solutions are generally too expensive for household coffee machines.

### SUMMARY

It is therefore an object of the present invention to provide a grinding attachment for a coffee machine which has a compact configuration and where the degree of grinding between two grinding tools can be adjusted with simple means.

The above and other objects are solved with a grinding attachment of the above generic type which in one embodiment includes: a grinding attachment casing; a support that is adjustable in a vertical direction; an upper grinding tool arranged inside the grinding attachment casing and attached to the support; a lower grinding tool which is rotatable relative to the upper grinding tool for a grinding operation; and an adjustment device for adjusting a degree of grinding for a material to be ground by the upper and lower grinding tools, the adjustment device including: a rotatable adjustment element to which the support is affixed torque-proof; and a guide for the support which, during a rotation of the adjustment element, moves the support with the upper grinding tool in a vertical direction to adjust a degree of grinding, for example with a force exerted by the upper grinding tool onto the lower grinding tool.

The degree of grinding may be adjusted through a rotational movement of an operating element, positioned on the bottom of the grinding container, so that no voluminous adjustment device with a gear is needed outside of the grinding attachment. A compact configuration is thus possible which allows designing the adjustment device with few components.

The support together with the upper grinding tool advantageously is removable from the grinding attachment casing, which permits an easy cleaning once the support with the upper grinding tool is removed, thus preventing a reduction in taste caused by older ground up material. The support together with the grinding tool, the adjustment element, and an operating element can form a removable unit.

For assembling the support and the upper grinding tool, the adjustment element can be attached with the aid of a bayonet locking device to the casing. The bayonet locking device can comprise at least one rib, preferably a rib projecting toward the inside, which prevents the operating element from being raised via a radial projection, wherein the projection is guided along the rib during a rotation of the operating element. Several projections and several ribs can be provided, distributed along the circumference, to prevent a tilting of the operating element and a one-sided load.

One embodiment provides that an upward-projecting operating element is provided on the adjustment element, by means of which the support can be rotated. The operating element can be positioned, for example, either completely or partially inside a container for storing the grinding material. The operating element can comprise a rotatable rod, provided at its upper end with an operating knob or other operating element, so that the degree of grinding can be adjusted manually via the operating element.

A seal may be installed between the support and the adjustment element, so that during a vertical displacement movement of the support, relative to the adjustment element, a seal is maintained to avoid or reduce the accumulation of contaminants in cavities. The adjustment element can contain a receptacle, open toward the bottom, into which the support is partially inserted.

According to a different embodiment, the upper grinding tool is mounted inside a ring that is positioned rotating in the casing and is provided with at least one latching element to secure the upper grinding tool in the adjusted position. A change in the degree of grinding is thus prevented, even in the event of vibrations caused by a grinding operation. The ring or the casing can be provided with at least one bendable hook which engages in a toothing, thus preventing a rotating movement between ring and casing following the adjustment.

Openings are advantageously provided in the center of the support and the operating element, which allow the grinding material to pass through. The grinding tools can be embodied as cones or grinding discs.

The inventive grinding attachment is advantageously used with a coffee machine having a bean container where the grinding attachment is arranged at the bottom. The coffee machine can be embodied such that the ground material is supplied to a filter container into which hot water flows, as described in the EP 3 225 142 A1. Or, it can be embodied such that the grinding attachment is arranged next to a hot-water feed-in, so that once the ground material is filled in, the filter container is moved to a brewing device, as disclosed in the EP 3 583 876 A1.

### BRIEF DESCRIPTION OF THE DRAWINGS

The invention is explained further in the following with the aid of an exemplary embodiment and reference to the enclosed drawings, which show in:

FIG. 1 A schematic view of an inventive coffee machine;

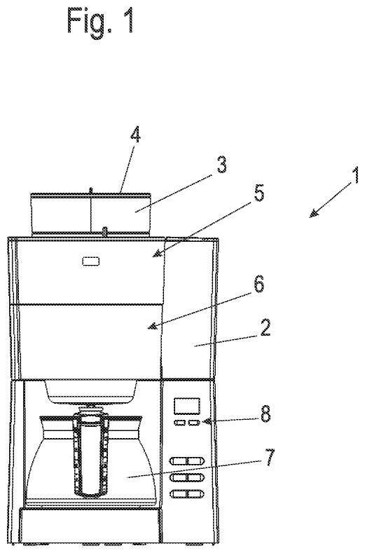

FIG. 2 A perspective representation of the inventive grinding attachment during the assembly;

FIGS. 3A and 3B Two views of the upper grinding tool with the operating element;

FIG. 4 A view of the bottom of the bean container for the grinding attachment;

FIGS. 5A and 5B Two views of the grinding attachment in the assembled position;

FIGS. 6A and 6B Two views of a snap-in device for the grinding attachment;

FIGS. 7A and 7B Two views of a holding ring for the grinding attachment; and

FIGS. 8A and 8B Two views of the ring for the snap-in device of the grinding attachment.

### DETAILED DESCRIPTION

A coffee machine 1 comprises a bean container 3 on a casing 2, which can be closed off with a lid 4. A grinding attachment 5 is arranged below the bean container 3 for supplying ground coffee to the filter arranged on a filter holder 6. Hot water can be filled via a pump and a heater into the filter, so that brewed coffee can flow into a container 7. The coffee machine 1 is controlled via a control panel 8 and comprises a casing 2, inside of which the grinding attachment 5 is arranged between the bean container 3 and the filter holder 6. It is also possible to arrange the grinding attachment separately from the coffee machine 1 or to grind a different material than coffee beans with the grinding attachment 5.

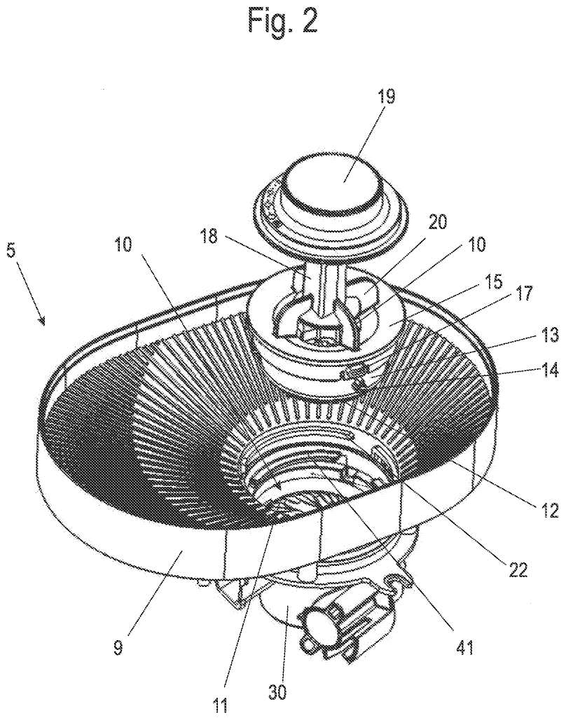

FIG. 2 shows the bottom 9 of the bean container 3 which is embodied tilting toward an opening 10 through which the coffee beans are moved for grinding. The grinding attachment 5 comprises a lower grinding tool 11, for example a grinding disc or a grinding cone, and an upper grinding tool 12 between which a grinding gap forms where the material is ground up. A spring can be used to prestress the upper grinding tool 12 relative to the lower grinding tool 11. For the exemplary embodiment shown, the lower grinding tool 11 is rotated with the aid of a motor.

The upper grinding tool 12 in this case is embodied as a grinding disc, but can also be embodied as grinding cone or other rotating grinding mechanism. The upper grinding tool 12 is mounted torque-proof on a support 13 which, in turn, is connected on its top to an adjustment element 15. The adjustment element 15 has an opening in the center for forming a channel 16 which extends from the bean container 3 through the adjustment element 15, the support 13, and the upper grinding tool 12.

The adjustment element 15 has an upward projecting operating element 18 in the form of a rod, with a rotary knob 19 affixed to the top or integrally formed therewith. The rotary knob 19 has markings showing the degree of grinding for the respectively adjusted position. Guide bars 20 are furthermore provided on the adjustment element 15 to facilitate guiding the coffee beans into the channel 16. At least one projecting rib 22 is embodied on the connector that surrounds the opening 10 on the bottom 9, which rib is designed to guide a projection 17 on the adjustment element 15. A guide element 41 in the form of a web is embodied in vertical direction below the rib 22, which guide element is oriented at an angle to the horizontal line. Via this guide element 41, the support 13 which is connected torque-proof to the adjustment element 15 can be moved vertically, relative to the adjustment element 15.

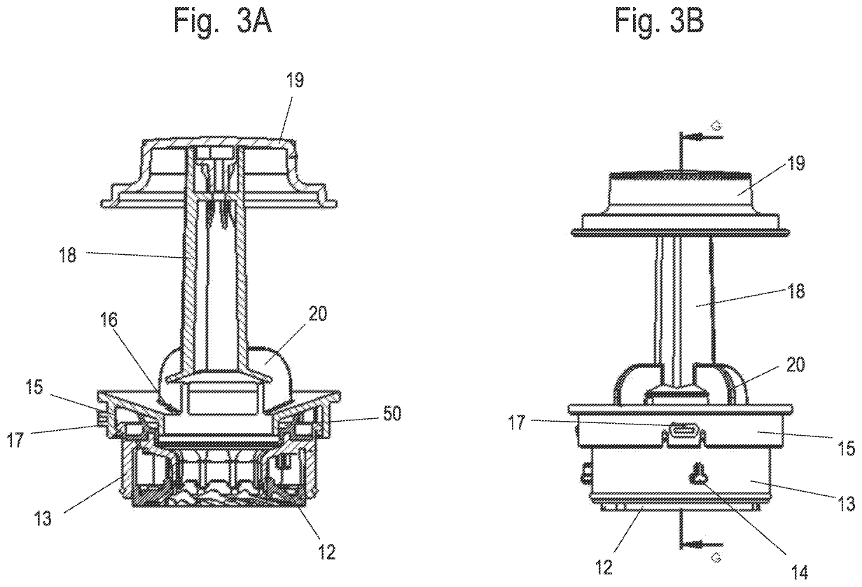

In FIGS. 3A and 3B, the adjustment element is shown in the removed position. In this position, the bottom 9 of the grinding attachment 5 and the lower grinding tool 11 can be cleaned. It is obvious that the adjustment element 15 forms a ring-shaped receptacle that is open toward the bottom and accommodates at least a portion of the support 13, wherein the support 13 is arranged toward the top with play inside the receptacle and can correspondingly be moved in vertical direction. A ring-shaped seal 50 is provided between the adjustment element 15 and the support 13 for sealing a gap between the support 13 and the adjustment element 15, in particular during a vertical displacement of the support 13. The upper grinding tool 12 is attached to the support 13.

A plurality of projections 14 can be embodied on the support 13, distributed over the circumference, which function as drivers when the adjustment element 15 is rotated. One or several projections 17 are also embodied on the adjustment element 15, which are distributed over the circumference and cooperate in the form of a bayonet locking device with the rib 22.

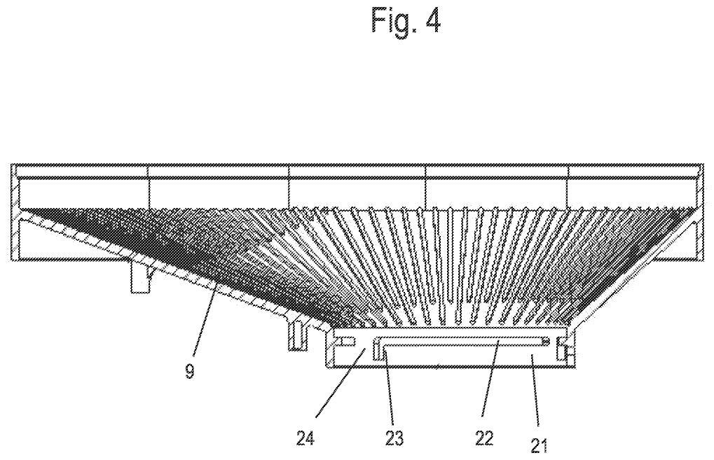

FIG. 4 shows the bottom 9 of the bean container 3. As can be seen, a connector 21 is provided around the opening, with several ribs 22 embodied thereon, distributed over the circumference, which project radially toward the inside and function to lock in place the projection 17 on the adjustment element 15, so that the adjustment element 15 cannot be lifted upward. A downward-pointing end stop 23 is provided on the rib 22 which limits the rotation of the adjustment element 15 on the connector 21. An opening 24 is provided between two adjacent ribs 22 on the connector 21 through which the projection 17 on the adjustment element 15 can be inserted.

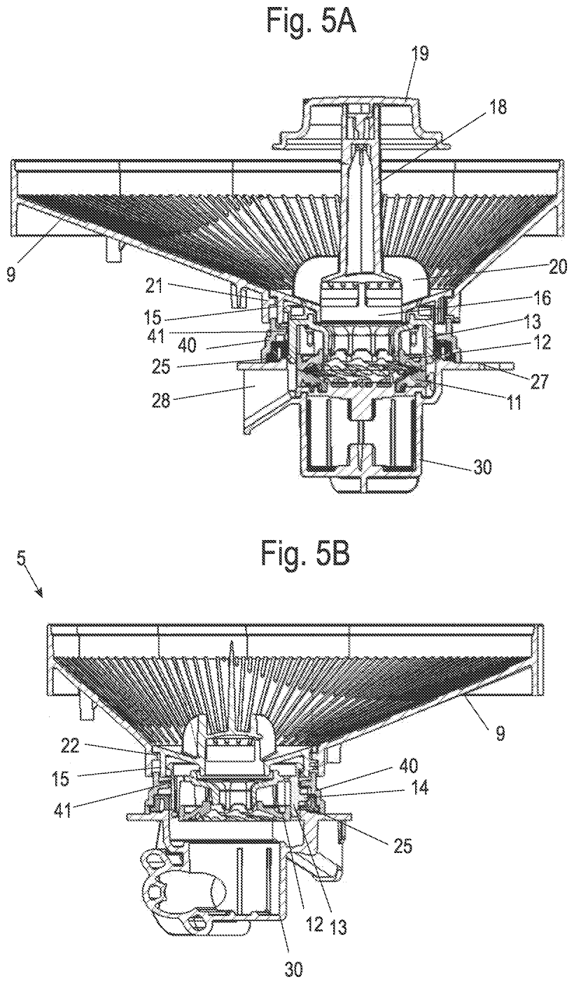

FIGS. 5A and 5B show the grinding attachment 5 in the fully assembled position. Coffee beans can reach the channel 16 via the bottom 9 and a slanted surface on the adjustment element 15, so as to reach the grinding gap between the upper grinding tool 12 and the lower grinding tool 11. The lower grinding tool 11 is positioned inside a casing 30 which can also accommodate a drive for rotating the grinding tool 11. From the grinding gap, the ground up material reaches a discharge 28 on one side of the lower grinding tool 11. A radially projecting flange 27 with an adjustable ring 25 attached thereto is located on the casing 30. A holder 40 is provided around the ring 25 on which the guide elements 41, projecting toward the inside, are embodied in the shape of slanted webs.

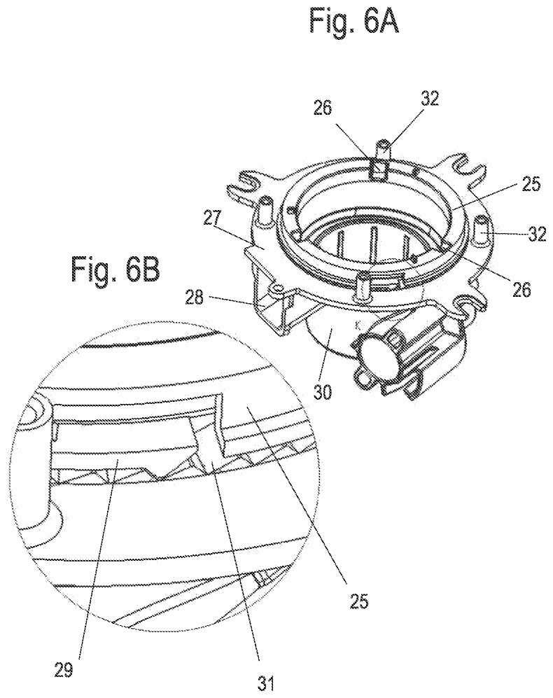

FIGS. 6A and 6B illustrate the area of the casing 30 at the flange 27 where the ring 25 is arranged. On the top, the ring 25 is provided with receptacles 26 at several locations into which respectively one driver 14 can be inserted that is embodied as projection on the support 13. The ring 25 can thus be connected torque-proof with the support 13. By turning the ring 25, the support 13 can be secured during the grinding attachment operation. One or several latching bars 29 are embodied for this on the ring 25 which engage in a toothing 31 on the casing 30. As a result of the latching bars 29, the support 13 can thus be rotated only if the holding force of the latching bars 29 is exceeded. Of course, latching bars or other holders engaging in a toothing on the ring 25 can also be formed onto the casing 30.

Upward pointing pins 32 are furthermore formed onto the flange 27, which are designed to fixate the holding ring 40.

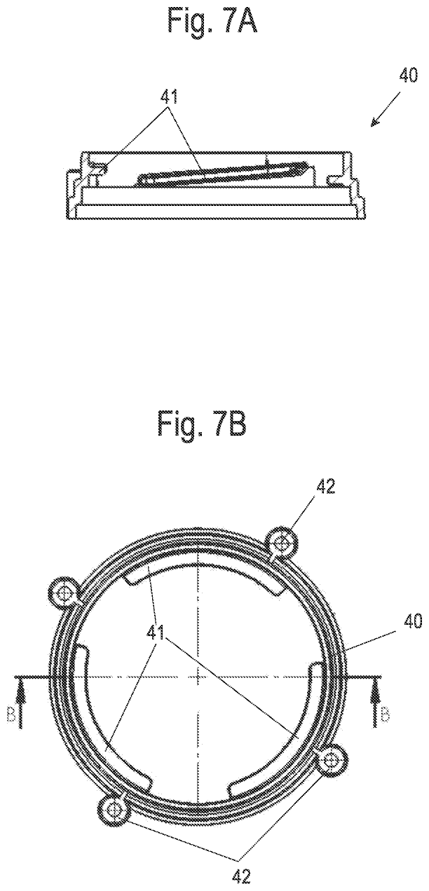

FIGS. 7A and 7B show the holding ring 40, provided on the inside with several webs pointing toward the inside and functioning as guide elements 41, which are embodied at a slant to the horizontal direction. During a rotation of the support 13, the projections 14 are displaced along the guide elements 41 and consequently move the support 13 in vertical direction together with the upper grinding tool 12. The holding ring 40 in the process is held torque-proof on the casing 30, wherein several holders 42 with eyelets are provided for this, which are fitted onto the trunnions 32 to create a torque-proof connection.

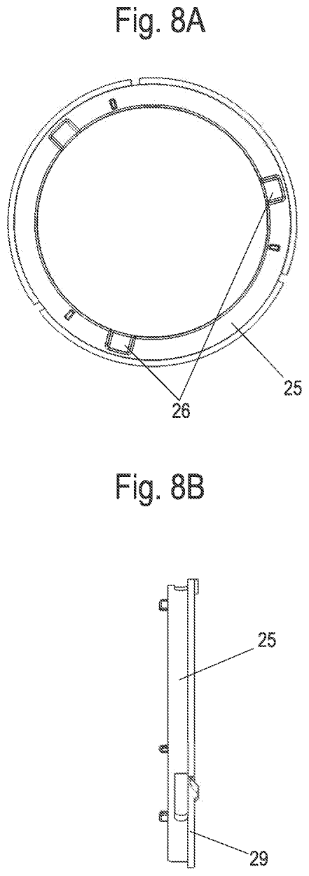

FIGS. 8A and 8B show the ring 25 which is arranged to rotate on the casing 30. The ring 25 rests on the top of the casing 30 and contains several receptacles 26 into which respectively one radially projecting driver 14 on the support 13 is inserted. As a result, the support 13 and the ring 25 can only be rotated jointly, wherein the rotational position, once it is reached, is secured via the latching bars 29.

The device for adjusting the degree of grinding can be located completely within the bean container 3. By rotating the adjustment element 15, the support 13 can be rotated along the guide element 41, without the use of a gear, so that it can be displaced in vertical direction, relative to the adjustment element 15. Optionally, the turning knob 19 or any other operating element can extend via an opening into the lid 4.

For the example shown, webs that point radially toward the inside are provided as guide elements 41 for adjusting the support 13.

Of course, it is also possible to embody the guide elements as a groove or profiled guide web.

Slanted guide ribs or grooves can furthermore also be embodied on the support 13, to cause a displacement of the support 13 in vertical direction, relative to the adjustment element 15.

It will be understood that the above description of the present invention is susceptible to various modifications, changes and adaptations, and that the same are intended to be comprehended within the meaning and range of equivalents of the appended claims.

1. A grinding attachment for use in particular with a coffee machine, comprising:
a grinding attachment casing;
a support that is adjustable in a vertical direction;
an upper grinding tool arranged inside the grinding attachment casing and attached to the support;
a lower grinding tool)which is rotatable relative to the upper grinding tool for a grinding operation; and
an adjustment device for adjusting a degree of grinding for a material to be ground up by the upper and lower grinding tools, the adjustment device including:
a rotatable adjustment element to which the support is affixed torque-proof; and
a guide for the support which, during a rotation of the adjustment element moves the support with the upper grinding tool in a vertical direction to adjust the degree of grinding.

2. The grinding attachment according to claim 1, wherein the support with the upper grinding tool is removable from the grinding attachment casing.

3. The grinding attachment according to claim 1, further including a bayonet locking device to secure the adjustment element with the support to the grinding attachment casing

4. The grinding attachment according to claim 3, wherein the bayonet locking device comprises at least one rib to prevent the adjustment element from being raised up and the adjustment element includes a projection that is guidable along the at least one rib during the rotation of the adjustment element.

5. The grinding attachment according to claim 1, wherein the adjustment element includes an upward projecting operating element arranged to rotate the support.

6. The grinding attachment according to claim 5, further including a container for storing the grinding material, wherein the upward projecting operating element is arranged at least partially inside the container.

7. The grinding attachment according to claim 5, wherein the upward projecting operating element comprises a rotatable rod.

8. The grinding attachment according to claim 1, further including a seal arranged between the support and the adjustment element.

9. The grinding attachment according to claim 1, wherein the support is inserted at least partially into a receptacle which has an open bottom and is located on the adjustment element.

10. The grinding attachment according to claim 1, further including a ring, wherein the upper grinding tool is arranged inside the ring which is rotatably positioned on the grinding attachment casing and includes at least one latching element to latch the upper grinding tool into an adjusted position.

11. The grinding attachment according to claim 10, wherein at least one of the ring and the grinding attachment casing includes a bendable latching hook for engagement in a toothing.

12. The grinding attachment according to claim 1, wherein the adjustment element and the support include a central opening through which grinding material is guidable.

13. A coffee machine with a bean container, including a grinding attachment according to claim 1.
